(19) United States
(12) Patent Application Publication
(10) Pub. No.: US 2023/0260054 A1
(43) Pub. Date: Aug. 17, 2023

(54) INFORMATION PROCESSING DEVICE AND INFORMATION PROCESSING METHOD

(71) Applicant: SIGNISCAPE, INC., Tokyo (JP)

(72) Inventor: Taiki YOSHIOKA, Tokyo (JP)

(21) Appl. No.: 18/007,825

(22) PCT Filed: Jun. 9, 2020
(86) PCT No.: PCT/JP2020/022699

§ 371 Date: Apr. 7, 2023

(51) Int. Cl. G06Q 50/00; G06Q 30/0273

(52) U.S. Cl. CPC G06Q 50/01; G06Q 30/0273

(57) ABSTRACT

An information processing device includes: a first receiver for receiving, from a first user, an original text in a first language, a request for translation of the original text, a designation of a second language for the translation, and a designation of a compensation for the translation; a second receiver for receiving, from one or more second users, without prior agreement with the first user, a translation of the original text into the designated second language; a first output for outputting to the first user a list of received translated texts; a third receiver for receiving approval of a translated text to be adopted from the list output by the first output; a provider for providing the compensation to a second user, from among the one or more second users, who uploaded the approved translated text; and a publisher for publishing the original text and the approved translated text.

### TECHNICAL FIELD

The present invention relates to an information processing device and an information processing method.

### RELATED ART

Known in the art is a technique whereby a text published on a network is translated into another language and republished. Patent Document 1 discloses a system whereby an information processing server provides a question and answer service (Q&A service) to a client terminal. This system enables a user to post a question in their native language, and another user to translate the question into another language. Patent Document 2 discloses a system whereby a user is able to connect to a server via the Internet by using a user terminal and make a translation request.

### PRIOR ART

### Patent Documents

Patent Document 1: JP 2016-151867A

Patent Document 2: JP 2009-110206A

### SUMMARY

### Problem to be Solved

In each of the systems disclosed in Patent Documents 1 and 2, a drawback exists in that a translation of published text can be published without prior approval of the publisher of the original published text.

In contrast, the present invention provides an environment in which a publisher of an original text is able to select a translated version of the text for publication.

### Solution

According to one aspect of the invention, there is provided an information processing device including: a first receiving means for receiving, from a first user, an original text in a first language, a request for translation of the original text, a designation of a second language for the translation, and a designation of a compensation for the translation; a second receiving means for receiving, from one or more second users, without prior agreement with the first user, a translation of the original text into the designated second language; a first output means for outputting to the first user a list of received translated texts; a third receiving means for receiving approval of a translated text to be adopted from the list output by the first output means; a providing means for providing the compensation to a second user, from among the one or more second users, who uploaded the approved translated text; and a publishing means for publishing the original text and the approved translated text.

The information processing device may further include: a generating means for generating a request for translation of the original text into the designated second language upon receipt by the first receiving means of the request for translation of the original text; and a second output means for outputting to the one or more users of the designated second language a list including the generated request.

The first receiving means may receive, in addition to the designated second language, a designated third language, the generating means may generate a request for translating the original text into the designated third language from the approved second language translation, in response to approval for the second language translation is received by the third receiving means.

The second output means may output a list of texts for which translation into the designated second language is requested, in response to access from the one or more users of the designated second language.

The publishing means may publish the translated text upon receipt of approval by the third receiving means.

The information processing device may further include distribution means for distributing an advertisement income to the first user and the second user according to an index of advertisement income for the translated text.

The information processing device may further include a third output means for outputting information that shows an amount of the compensation and the distributed advertisement income as a profile of the second user.

The list of texts for which translation into the designated second language is requested may include information indicating a number of translated texts already uploaded responsive to the request.

According to another aspect of the invention, there is provided an information processing method including: receiving, by a computer system, from a first user, an original text in a first language, a request for translation of the original text, a designation of a second language for the translation, and a designation of a compensation for the translation; receiving, by the computer system, from one or more second users, without prior agreement with the first user, translation of the original text into the designated second language; outputting, by the computer system, to the first user, a list of received translated texts; receiving, by the computer system, approval of the translated text to be adopted from the list output by the first output means; providing, by the computer system, the compensation to a second user from among the one or more second users, who uploaded the approved translated text; and publishing, by the computer system, the original text and the approved translated text.

### Advantageous Effects

According to the present invention, a publisher of original text, an article, etc., is able to select a translated version of the text for publication.

### BRIEF DESCRIPTION OF THE DRAWINGS

FIG. 1 shows a configuration of an information processing system according to an embodiment.

FIG. 2 shows a functional configuration of a server according to an embodiment.

FIG. 3 shows a hardware configuration of a server according to an embodiment.

FIG. 4 shows a hardware configuration of a client terminal according to an embodiment.

FIG. 5 shows a sequence chart showing an operation of an information processing system according to an embodiment.

FIG. 6 shows a screen display for posting a text.

FIG. 7 shows a screen display of the translation request list.

FIG. 8 shows a screen display for posting a translated text.

FIG. 9 shows a screen display of the translated text list is illustrated.

FIG. 10 shows a flowchart of an advertisement income aggregation and distribution process.

FIG. 11 shows an example of the translator's profile screen.

### DESCRIPTION OF REFERENCE NUMERALS

1 . . . Server, 2 . . . Network, 11 . . . Receiving means, 12 . . . Payment providing means, 13 . . . Report disclosure means, 14 . . . Request generating means, 15 . . . Income distribution means, 16 . . . Output means, 17 . . . Storage means, 101 . . . Processor, 103 . . . Interface, 104 . . . Communication section, 111 . . . Translated text receiving means, 113 . . . Approval receiving means, 161 . . . Translated text list output means, 162 . . . Request the list output means, 163 . . . Profile output means, 302 . . . Storage device, 303 . . . Interface, 304 . . . Communication unit, 305 . . . Display device, 306 . . . input device, 312 . . . Body field, 313 . . . Original text language specification field, 314 . . . Tag designation field, 315 . . . Request annotation field, 316 . . . Translation target language designation field, 317 . . . money amount designation field, 318 . . . currency designation field, 319 . . . operation button, 331 . . . search condition setting field, 332 . . . source language designation field, 333 . . . translation target language designation field, 334 . . . source text display field, 351 . . . title field, 352 . . . body field, 353 . . . request annotation field, 354 . . . translation description field, 355 . . . operation button, 361 . . . text list display field, 362 . . . icon, 371 . . . profile field, S . . . information processing system

### DETAILED DESCRIPTION

### 1. Configuration

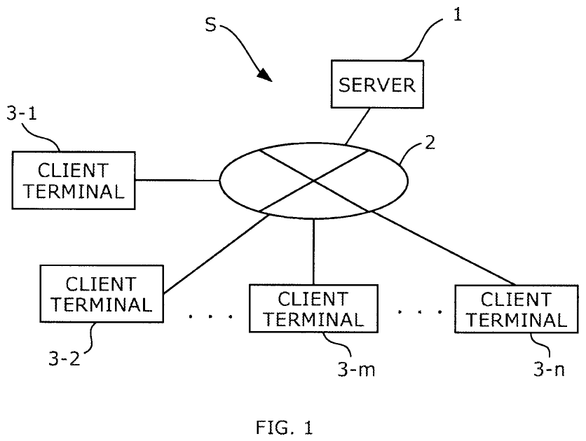

FIG. 1 shows an exemplary configuration of an information processing system S including a server 1, which is an information processing device according to an embodiment. Information processing system S is a computer system that provides a service (hereinafter referred to as “a text sharing service”) for uploading and publishing text on the Internet. Text can be uploaded and published in any language. A user who publishes text can request translation of the text, and in response to the request another user may upload a translation of the text. Hereinafter, an original text (that is, a text before translation) is referred to as an “original text,” and a translation of the text is referred to as a “translated text.” Original texts and translated texts are collectively referred to simply as “texts.”

Information processing system S has plural client terminals 3-1, 3-2,., 3-n (hereinafter, collectively referred to as client terminals 3 if not distinguished) connected to server 1 via network 2.

Network 2 is a computer network such as the Internet. Server 1 and client terminal 3 are connected to a network 2. Each of server 1 and client terminal 3 communicates via network 2 with other device(s) connected to network 2.

Server 1 receives a text provided from client terminal 3. Server 1 publishes the received text. Publication of a text refers to transmitting the text to another client terminal 3 that has accessed server 1. In addition to providing a text to server 1, client terminal 3 can display a text transmitted from server 1. Further, client terminal 3 can upload a translation of a text that has already been published. The uploaded translation is published after approval of the user who published the original text.

Users of client terminal 3 can take at least one of the following three actions: (i) publish an original text; (ii) upload a translation of a text; and (iii) browse texts. Users of information processing system S can perform each of the actions. That is, the users are divided into plural categories, and actions of the users are not restricted to any one category. However, for convenience of explanation, a user who publishes an original text is referred to as an “original text publisher,” and client terminal 3 used by the original text publisher is referred to as an “original text publisher terminal 3.” A user who uploads a translation of a text is referred to as a “translator,” and client terminal 3 used by the translator is referred to as a “translator terminal 3.” A user who reads the published text is referred to as a “general user,” and client terminal 3 used by the general user is referred to as a “general user terminal 3.”

In the present embodiment, client terminal 3-1 is the original text publisher terminal, client terminal 3-2 is the translator terminal, and client terminal 3-m is the general user terminal. Although one original text publisher terminal, one translator terminal, and one general user terminal are shown in FIG. 1, plural ones of these terminals may be provided.

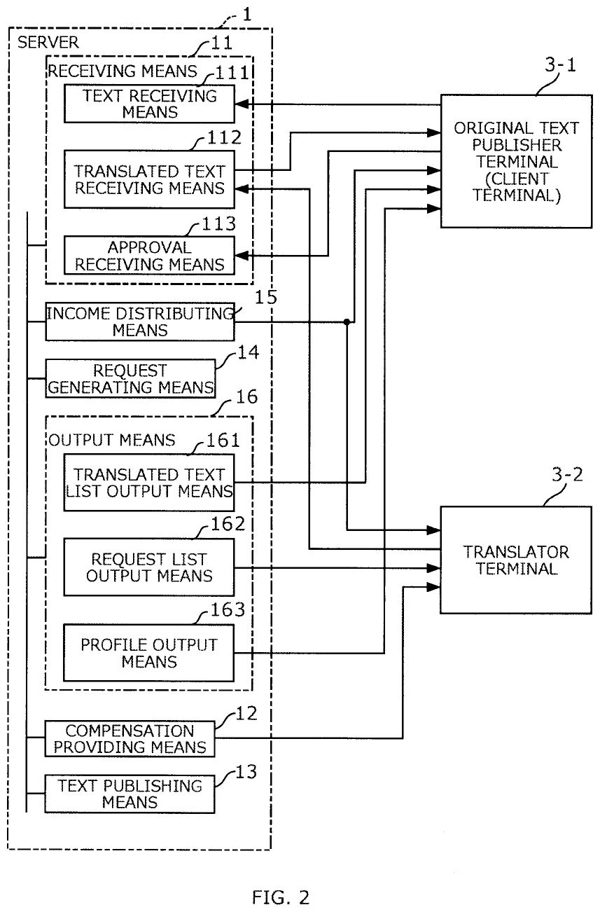

FIG. 2 is a block diagram showing a functional configuration of server 1. Server 1 includes receiving means 11, compensation providing means 12, text publishing means 13, request generating means 14, income distributing means 15, output means 16, and storage means 17.

Receiving means 11 receives various inputs via operations at client terminal 3. Receiving means 11 includes text receiving means 111, translated text receiving means 112, and approval receiving means 113. Text receiving means 111 receives input of an original text. Specifically, text receiving means 111 receives, from the original text publisher terminal 3: a post of the original text in its original (first) language, a request for translation of the original text, a designation of a second language that is a translation target language, and a designation of a compensation for the translation. Translated text receiving means 112 receives input of a translated text. Approval receiving means 113 receives approval of a translated text to be adopted from the original text publisher terminal 3. Specifically, when plural translated texts are received from plural translators by translated text receiving means 112, approval receiving means 113 receives approval of a translated text to be adopted, from among the plural translated texts, by the original text publisher.

Compensation providing means 12 provides compensation to the translator who uploaded the adopted translated text when approval of the translated text to be adopted by approval receiving means 113 is received. Specifically, when the translated text is approved by the original text publisher, compensation providing means 12 performs a process of payment of compensation from the original text publisher to the translator. The compensation is designated by the original text publisher in text receiving means 111. The compensation is, for example, money, and a process is performed by which an amount of money as the compensation is paid from the original text publisher to the translator. At this time, a part of the compensation is paid to the operator of server 1.

Text publishing means 13 publishes a text. Specifically, the text published by text publishing means 13 includes, in addition to the original text, a translation of the text that has been approved by approval receiving means 113 from among the uploaded translations. In response to a request from client terminal 3, text publishing means 13 outputs data that displays the original text and the translation of the text on the display device of client terminal 3.

The request generation means 14 generates a request for translation of the original text from the first language to the designated second language, upon receipt of a request for translation of the original text by the text receiving means 111.

Income distribution means 15 distributes income associated with the text to the original text publisher and to the translator. The income associated with the text includes, for example, advertisement income generated by the text and income billed for readership of the text. First, taking billed income as an example. Income distribution means 15 performs a process to distribute advertisement income to the original text publisher and to the translator in accordance actions of general users of the text. When publishing a text, text publishing means 13 performs a process to include with the text information relating to an advertisement (for example, a link to an advertisement web page). Income distribution means 15 distributes the advertisement income in accordance with actions on the information related to the advertisement. Actions on information related to an advertisement include, for example, clicking on a link. The advertiser pays to the operator of server 1 advertisement compensation calculated dependent on a number of times the link is clicked on. Income distribution means 15 distributes at least a part of the advertisement compensation to the original text publisher and to the translator. In this example, the operator of server 1 also receives a part of the advertisement income.

Output means 16 outputs various kinds of information to client terminal 3 via network 2. Output means 16 includes translated text list output means 161, request list output means 162, and profile output means 163.

Translated text list output means 161 provides, to original text publisher terminal 3, a list of translated texts received by translated text receiving means 112. The list of translated texts is provided for approval of a translated text for adoption by the original text publisher. Specifically, the list of translated texts is displayed on the display of original text publisher terminal 3, and the original text publisher approves a translated text to be adopted from the displayed list. As described above, information indicating the approved translated text is received by approval receiving means 113.

Request list output means 162 outputs a list of translation requests (requests to translate the original text from the first language to the designated second language) to translator terminal 3. Specifically, request list output means 162 outputs a list of texts for which a request for translation into the designated second language in response to access from a translator who is a user of the second language. Details of an operation are as follows. Requests provided by the plurality of original text publishers received by text receiving means 111 include requests for translation into various languages. Request list output means 162 extracts a request for translation into a specific language (here, the second language) from among these requests. Request list output means 162 outputs a list of texts of the extracted request.

Profile output means 163 outputs a profile of a user. The profile of a user includes, for example, an amount of compensation provided to the user by compensation providing means 12 as a translator, and an amount of advertisement income distributed to the user by income distribution means 15 as a translator.

Storage means 17 stores various data. The data stored in storage means 17 includes a text database and a user database. The text database is a database in which texts are stored (or recorded) for provision to information processing system S. The user database is a database in which profile or attribute information of the user is stored. A user who wishes to use the text sharing service performs user registration. When registering as a user, the user completes a profile, e.g., user ID (and/or username), native language, translation languages, educational background, occupation, and/or place of residence.

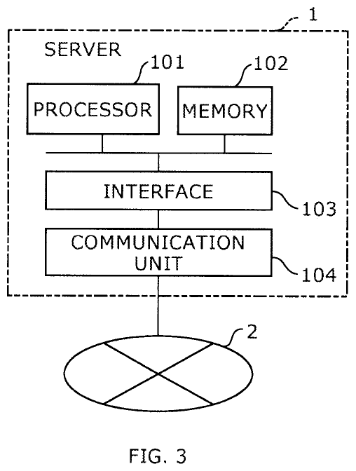

FIG. 3 is a block diagram showing a hardware configuration of server 1. Server 1 is a computer including processor 101, storage device 102, interface 103, and communication unit 104. These elements are operably connected to each other by, for example, a bus.

Processor 101 controls each unit of server 1 by reading and executing a computer program (hereinafter, simply referred to as a program) stored in storage device 102. Processor 101 is, for example, a CPU (Central Processing Unit). Storage device 102 stores an operating system loaded into processor 101, various programs, data, and the like. Storage device 102 includes a main storage device and an auxiliary storage device. The main storage device includes, for example, a RAM (Random Access Memory) and a ROM (Read Only Memory). The auxiliary storage device includes a solid-state drive and/or a hard disk drive. Interface 103 relays a signal between processor 101 and communication unit 104. Communication unit 104 controls communication with another device, for example, client terminals 3-1, 3-2,., 3-n, via network 2.

In this example, the program stored in storage device 102 includes a program (hereinafter referred to as a “server program”) that causes a computer to function as a server for information processing system S. Processor 101 executes the server program to implement the functions shown in FIG. 2 in the computer. In a state in which processor 101 executes the server program, processor 101 is an example of receiving means 11, compensation providing means 12, text publishing means 13, request generating means 14, income distributing means 15, and output means 16. Storage device 102 is an example of the storage means 17.

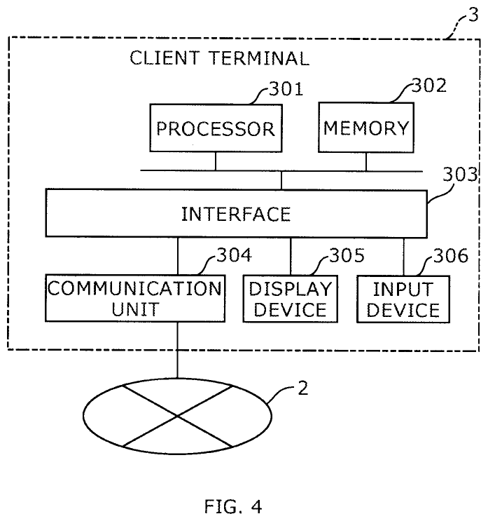

FIG. 4 is a block diagram showing a hardware configuration of client terminal 3. Client terminal 3 is a computer including a processor 301, storage device 302, interface 303, communication unit 304, display device 305, and input device 306, for example, a personal computer, a smartphone, or a tablet device. These elements are operably connected to each other by, for example, a bus.

Processor 301 controls each unit of client terminal 3 by reading and executing a computer program (hereinafter, simply referred to as a program) stored in the storage device 302. Processor 301 is, for example, a CPU (Central Processing Unit). The storage device 302 stores an operating system loaded into processor 301, various programs, data, and the like. Storage device 302 includes a main storage device and an auxiliary storage device. Interface 303 relays signals between processor 301 and other elements. Communication unit 304 controls communication performed with another device, for example, server 1, via network 2. Display device 305 is a device that visually outputs images and characters, and includes, for example, a liquid crystal display. Input device 306 is a device that receives input of various kinds of information in response to an operation performed by a user, and includes a keyboard, a mouse, a touch screen, and the like.

### 2. Operation

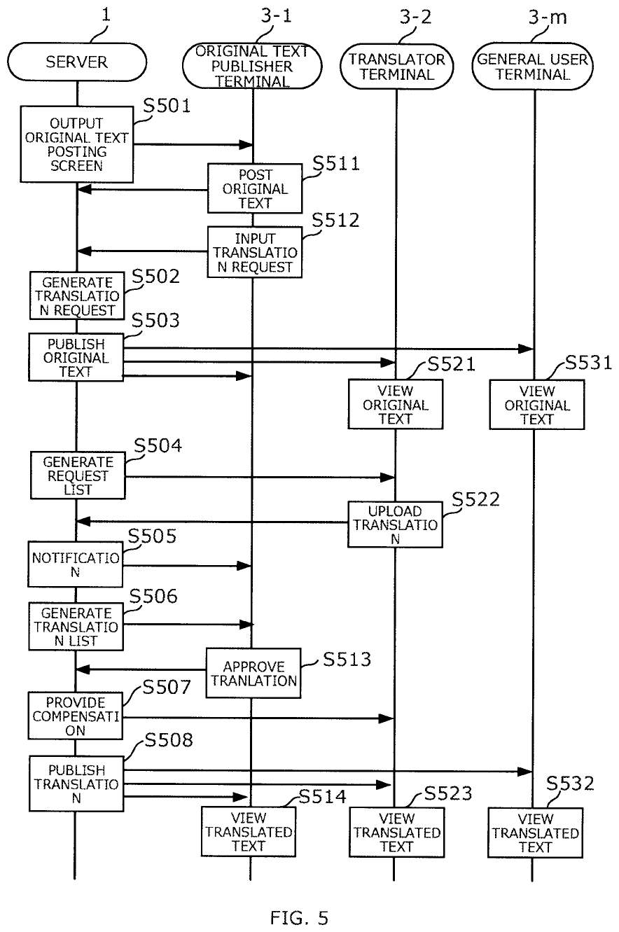

FIG. 5 shows a sequence of a process in information processing system S. Operation of information processing system S is described here in stages of providing an original text, uploading a translation of the original text, approving the translation of the original text, distributing advertisement income, and showing a profile of a user. Functional elements such as text receiving means 111 may be viewed here as a subject of a process, in that a hardware element such as processor 101 upon executing a program such as a server program cooperates with other hardware elements such as storage device 102, thereby to execute the process.

### 2-1. Provision of Original Text

The user of original text publisher terminal 3-1 (an example of the first user, who posts the original text) accesses server 1 to publish a text. For example, a general-purpose web browser or a dedicated application is used to access server 1. In response to a request from the original text publisher terminal 3-1, server 1 outputs (at step S501) a posting screen (hereinafter, referred to as “original text posting screen”) for publishing the original text. A posting screen is displayed on the display device 305 of the original text publisher terminal 3-1.

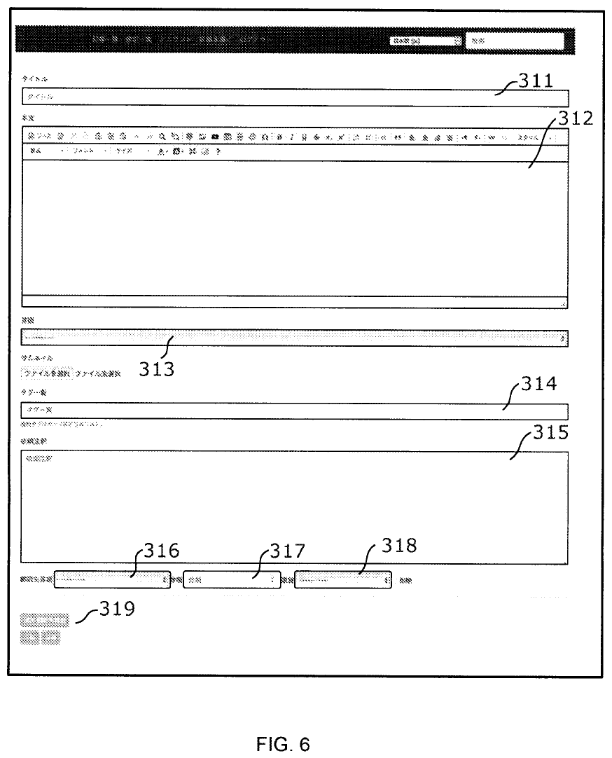

FIG. 6 shows an example of an original text publishing terminal. The original text posting screen includes title field 311, body field 312, original text language designation field 313, tag designation field 314, request annotation field 315, translation target language designation field 316, amount designation field 317, currency designation field 318, operation button 319, and the like.

Title field 311 is a UI object for inputting a title of the original text to be published. Body field 312 is a UI object for inputting the body of the original text. Source text language designation field 313 is a UI object for inputting descriptive language of the source text input in the body text field 312. Tag designation field 314 is a UI object for inputting a tag. The tag is a word(s) for classification that assists a translator or a general user in searching an input source text. The tag specifies, for example, the genre of the text (e.g., entertainment, sports, science, politics, etc.). Plural tags may be input. Request annotation field 315 is a UI object for inputting a request, a precaution, and the like to the translator. An example of a request, may be, for example, “it is not necessary to translate the text directly, and it is desirable to aim for ease of readability in each country for publication” or the like.

Translation target language designation field 316 is a UI object for designating a translation target language. A candidate is set in advance as the translation target language, and the original text publisher designates the translation target language from among these candidate languages. Money amount designation field 317 is a UI object for inputting an amount of money for the translation. Currency designation field 318 is a UI object for designating a currency (for example, Japanese yen, US dollars, or the like) of the amount of money entered in amount designation field 317. Although only a target language designation field is shown in the example of FIG. 6, translation target language designation field 316, amount designation field 317, and currency designation field 318 may be included in accordance with the user's operation. Also, plural translation target languages may be designated. In this case, compensation can be set for each of the translation target languages.

Operating buttons 319 are UI objects for inputting instructions to server 1. In this example, operation button 319 includes a publish button and a save button. If the publish button is clicked, the information input in each field is uploaded to server 1, and is published after the reception process in server 1. If the save button is clicked, the above described input text is uploaded to server 1 and stored in server 1, but is not published. In a case where input for all the fields has not been completed, or in a case where the user wishes to stop the input process and resume the operation later, the user may click the save button to save the input text.

Referring again to FIG. 5, the original text publisher publishes (at step S511) the original text via the original text input window. Further, the original text publisher inputs (at step S512) a request for translation of the original text. The request for translation includes designation of a target language and designation of a compensation amount. In the example shown in FIG. 6, the input of the original text and the request for translation are performed on the same screen.

Text receiving means 111 in server 1 receives the original text and the translation request input via the screen shown in FIG. 6 of the original text publisher terminal 3-1. Upon receiving input of the original text, server 1 writes the received original text into the text database of the storage means 17. The text database includes attribute information of the text and data for the text body. The attribute information of the text includes, in addition to the information input via the original text input window in FIG. 6, a text ID, a language of the translated text, a translated text ID, and a flag indicating whether the translated text can be published. If the publish button of the operation button 319 is pressed, the value of the flag is set to “available,” and if the save button is pressed, the value of the flag is set to “not available.” A text for which the value of the flag is set to “not available” can be viewed only by the user who wrote the text.

Upon receiving the translation request, the request generation means 14 generates (at step S502) translation request information based on the received original text and the translation request. The translation request information includes information on the original text ID, The original text publisher ID, the translation source language, the translation target language, and the compensation. For example, an example is envisaged in which Japanese is designated as the language of the original text in the original text input screen in FIG. 6, and English, Chinese, and German are designated as the translation target languages, for the original text three pieces of translation request information are generated: namely, Japanese to English, Japanese to Chinese, and Japanese to German. The request generation means 14 stores the generated translation request information in the text database of the storage means 17.

Text publishing means 13 in server 1 publishes (at step S503) the original text received from the text publisher terminal 3-1. Upon receiving a request for viewing a text from client terminal 3, text publishing 13 transmits the text in response to the request. The request for viewing the text includes information identifying the text or information for narrowing down content of the text. The information specifying the text is, for example, a text ID. Examples of the information for narrowing down the content of the text include a text ID, a tag, a user ID, and/or a keyword. If a single text is designated by the text ID, text publishing means 13 transmits data for displaying the text at client terminal 3. If plural texts are extracted for the text ID, the tag, the user ID, and/or the keyword, text publishing means 13 transmits a list of the extracted texts to be displayed at client terminal 3. In this way, in the translator terminal 3-2 and the general user terminal 3-m, the translator and the general user can respectively view (at step S521 and step S531) the original text.

### 2-2. Uploading Translated Texts

A user of the translator terminal 3-2 (an example of a second user; a user serving as a translator) accesses server 1 to upload a translated text. Specifically, the translator terminal 3-2 transmits a request for a translation request list to server 1. The request for the translation request list includes information for narrowing down the translation request. The information for narrowing down the translation request includes at least information specifying a translation source language and a translation target language. In addition, the information for narrowing down the translation request may include information about a tag, compensation, keywords, and/or the number of translations that have already been uploaded. As an example, the information for narrowing down the translation request includes information on “genre: sport”, “first language: Japanese”, “second language: English”, and “compensation: 20,000 yen or more.” The request generation means 14 extracts a translation request matching the request of the translation request list from the text database. The request list outputting means 162 generates (at step S504) a translation request list including the extracted translation request. Request list output means 162 transmits the generated translation request list to the translator terminal 3-2 of the request source.

Upon receiving the translation request list from server 1, the display device 305 of the translator terminal 3-2 displays the translation request list. The translator selects the source text to be translated from the displayed translation request list.

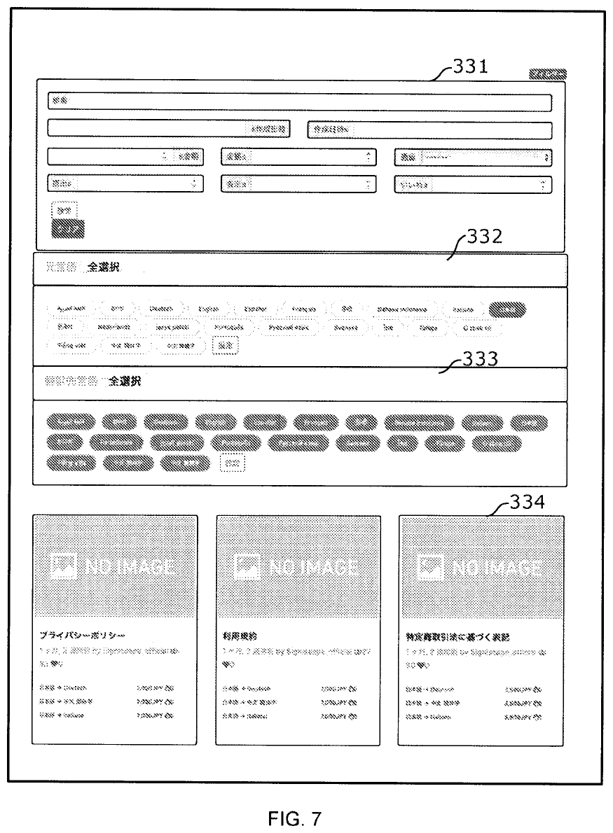

FIG. 7 shows an example of a translation request list. The translation request list screen includes search condition setting field 331, source language designation field 332, translation target language designation field 333, and source text display field 334.

The search condition setting field 331 is a UI for inputting a search key for narrowing down (or searching) the translation request. In this example, the search condition setting field 331 includes a keyword input field, a range designation field of the creation date and time of the original text, a range designation field of the amount of compensation, a designation field of the currency, a range designation field of the submission deadline for the translated text, a designation field of the number of translated texts that have already been uploaded, a designation field of the number of displays of the search results, and the like. The translator can search the original text by inputting conditions in each of these fields.

The source language designation field 332 is a UI object for designating the language of the source text. In the source language designation field 332, plural languages can be designated. The translation target language designation field 333 is a UI object for designating a translation target language. In the translation target language designation field 333, plural languages can be designated.

The source text display field 334 is a UI object for displaying a translation request that matches the conditions input in search condition setting field 331, source language designation field 332, and translation target language designation field 333. In the original text display field, a title of each original text and content of the request (the language of the original text, the language of the translation target, and the compensation) are displayed as thumbnails. If a thumbnail is clicked, the displayed screen switches to the view screen of the original text. The view screen of the original text includes a UI object (for example, a translation button) for switching the translated text to the uploading screen. If switching of the translated text to the uploading screen is instructed via UI object, the displayed screen is switched to the translation uploading screen for uploading the transition of the original text. The method of switching the screen to be displayed to the translation uploading screen is not limited to the foregoing, and may be switched to the translation text uploading screen directly from the translation request list screen shown in FIG. 7, for example, without passing through the original text view screen.

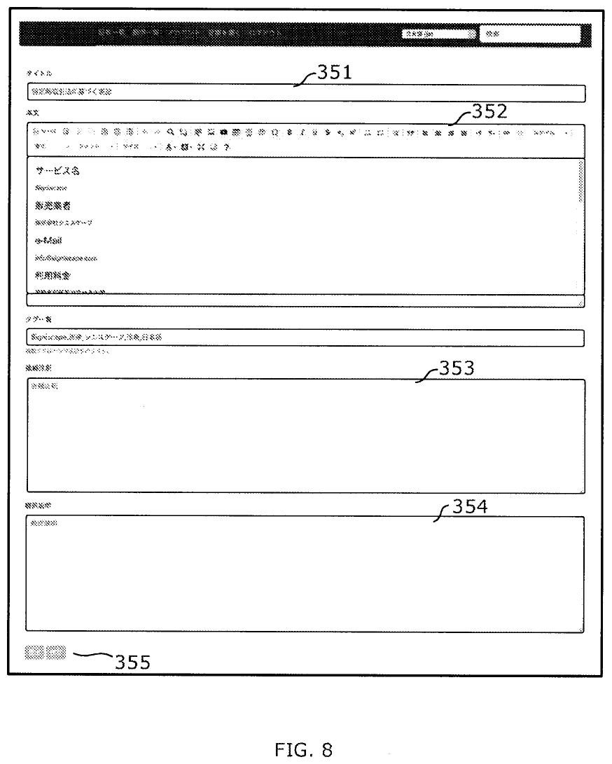

FIG. 8 shows an example of the translation uploading screen. The translation uploading screen includes title field 351, body field 352, request annotation field 353, translation description field 354, and operation button 355.

Title field 351 is a UI object for inputting the translation of the title of the original text. In title field 351, the title of the original text is displayed as an initial value in the translation source language. The translator can provide input while viewing the title in the translation source language. Body field 352 is a UI for inputting translated text of the body of the original text. In the body column 352, the body of the original text is displayed as an initial value in the translation source language. The translator can provide input while viewing the body of the displayed original text.

Request annotation field 353 is a UI object for displaying the request annotation described in the translation request of the original text publisher. Translation description field 354 is a UI field for the translator to enter a supplementary description or the like for the translated text. In this example, request annotation field 353 can also be edited, that is, the translator can input the translation of the request annotation input by the original text publisher. Accordingly, even if a translated text is translated into another language, as described later, a request item from the original text publisher can be transmitted to a translator in another language.

Operation buttons 355 are UI objects for inputting an instruction to server 1. In this example, the operation button 355 includes a submit button and a save button. If the submit button or the save button is clicked, the above-described input content is uploaded to server 1.

Referring again to FIG. 5, the translator uploads (at step S522) the translated text via the translation uploading screen. Specifically, the operation button 355 is clicked on the translation uploading screen shown in FIG. 8.

Upon receiving the translated text from the translator terminal 3-2, server 1 records the translated text in the text database. In addition to the input information, attribute information on the translated text is recorded in the text database. The attribute information includes a translated text ID, an original text ID, a flag indicating whether the translated text can be submitted, a flag indicating whether the translated text can be published, and a user ID of the translator. If the submission button of the operation button 355 is pressed, the value of the flag is set to “submittable,” and if the save button is pressed, the value of the flag is set to “submittable.” Only the translator who posted the translated text can view the translated text in which the value of the flag is set to “not submitted.” A translated text whose flag value is set to “submittable” can be viewed by the original text publisher in addition to the translator who uploaded the translated text. The initial value of the publication availability flag is “available” and is not published until the translated text is approved by the original text publisher.

It is of note that uploading the translated text described above is performed without prior agreement with the original text publisher (that is, not depending on prior agreement). Prior agreement means that the original text publisher pays the translator for the translation of the text prior to uploading the translation of the text. Conventionally, a client and a translator are first matched to a case, and the translator uploads the translation after the matching is established (i.e., after an agreement is made that the client will pay compensation for the translation). On the other hand, in the present embodiment, uploading the translated text is performed without prior agreement with the original text publisher. That is, it is not guaranteed that compensation will be received by a translator who uploads a translation of the text to the original text publisher. By deploying a competitive system, in the present embodiment, a high-quality translation of a text can be obtained at a lower cost.

### 2-3. Approval of Translated Texts

If a translated text flagged as “submittable” is added to the text database, the translated text means 112 of server 1 transmits (at step S505) a notification indicating that the translated text has been uploaded, to the original text publisher terminal 3-1 that published the original text of the translation. Upon receiving this notification, the original text publisher accesses server 1 from the original text publisher terminal 3-1. Specifically, the original text publisher terminal 3-1 transmits a request for a text list to server 1.

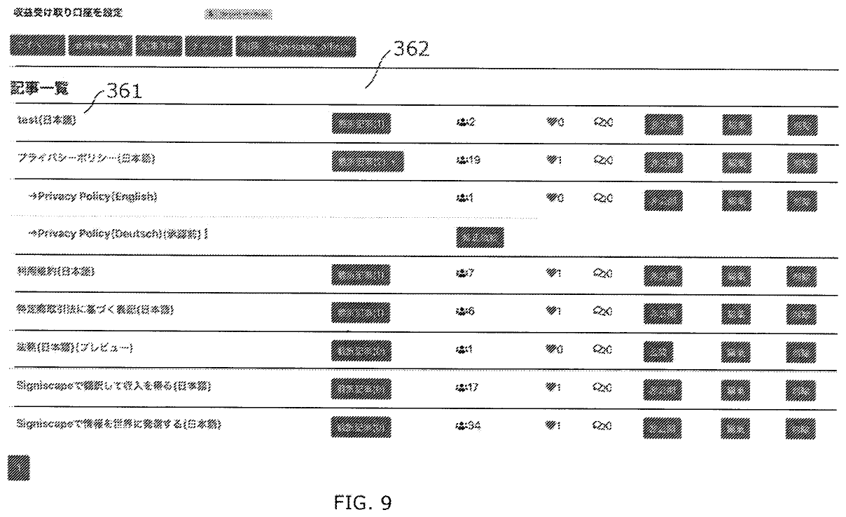

FIG. 9 shows an example of list of texts. The text list screen includes a text list display field 361. The text list display field 361 is a UI object for displaying a list of texts uploaded by the user. The list of texts includes information identifying each text, in this example, a title of the text. Further, in this example, icon 362 is displayed for each of text. If the text is the original text, icon 362 is a UI object indicating a presence or absence of the translated text relative to the original text. If there is a translated text corresponding to the original text, a number is displayed. If any of the translated texts are not approved, icon 362 includes information indicating a number of translated texts that are not approved. In the example shown in FIG. 9, icon 362 for the text “privacy policy” which is at the second top includes a character string “translated text (2)” and an image of a circle in which a number “1” is shown. The string “translated text (2)” indicates that there are two translated texts for the original text. The image of a circle with the number “1” indicates that one of the two translated texts is not approved or is unauthorized. If icon 362 is clicked, display/non-display of the translated text is switched. FIG. 9 shows a state in which a translated text corresponding to the original text “privacy policy” is displayed. Information indicating a language in which the text is described is added to the titles of the original text and the translated text. If a translated text in the second language is uploaded by plural translators for an original text, plural translated texts are displayed (that is, a list of corresponding translated texts).

If the original text publisher clicks on the title of the translated text, the translated text is displayed. The original text publisher can confirm the contents of the translation on the translated text view screen. The translated text view screen includes a UI object (for example, a button) for instruction of approval (or select) the translated text as a translation of the original text. If the original text publisher inputs an instruction via a UI object (for example, to press a button), the original text publisher terminal 3-1 transmits to server 1 (at step S513) information indicating that the text has been approved (that is, a translated text has been selected).

Referring again to FIG. 5, upon receiving an instruction to approve the translated text from the original text publisher terminal 3-1, compensation providing means 12 of server 1 performs (at step S507) a process of providing compensation to the translator who uploads the approved translated text. The amount of money as the compensation is the amount of compensation specified in the translation request when the original text publisher published the original text. Out of the amount of compensation, a part (for example, 10%) is paid to the operator of server 1 (the operator of the translation site), and the remainder (for example, 90%) is paid to the translator. As a method of the payment processing, for example, the payment processing is performed by connecting to a payment processing site outside server 1. Compensation providing means 12 completes the settlement process by performing the process of loading and unloading the amount with respect to each of a credit card or a bank account of the original text publisher registered at the settlement processing site, the bank account of the translator, and the bank account of the operator.

Upon completion of the settlement process or independently of the settlement process, text publishing means 13 publishes (at step S508) the translated text. Specifically, in the text database, the text publishing means 13 rewrites a flag indicating whether the translated text can be opened to the public as “available”. The translated text whose flag is “publicly available” is published in the same manner as the original text in response to a browsing request from client terminal 3. Each client terminal 3 displays (at steps S514, S523, and S532) the translated text. Further, text publishing means 13 assigns an advertisement to a translated text to be published. When a translated text is viewed on each of client terminals 3, information related to an advertisement is displayed together with the translated text on the display device 305 of each of client terminals 3. If there is a corresponding text in another language, the text view screen of the language includes a link to the text view screen of the other language. In this way, the original text and the translated text, or the translated texts in different languages, are linked to each other.

### 2-4. Distribution of Advertising Income

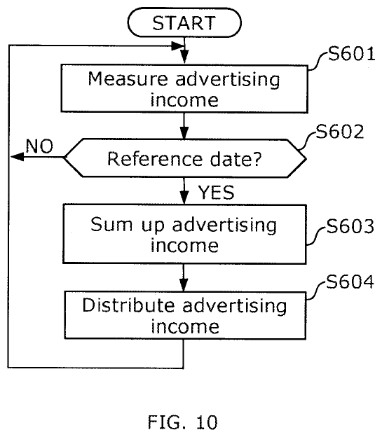

FIG. 10 is a flowchart showing a process of distributing advertisement income. Text publishing means 13 of server 1 measures (at step S601) advertising income based on page views. The measured advertisement income is recorded in a text database. For example, the advertisement income depends on the cumulative value of the page view each month. Income distribution means 15 determines (at step S602) whether the data is the reference date (so-called closing date) of the income distribution. The reference date of the income distribution is, for example, the last day of each month. If the date is not the reference date (step S602: NO), income distribution means 15 waits until the reference date. If the date is the reference date (step S602: YES), income distribution means 15 progress the process to step S603.

Income distribution means 15 sums up (at step S603) the advertising income obtained for the translated text during the period. The operator of server 1 obtains the advertisement income from the advertiser according to a predetermined index, for example, a number of times the advertisement of the translated text is viewed at each client terminal, the number of clicks of the banner, or the number of purchases after the transition to the advertisement. In the text database, the amount of the advertisement income obtained from a text is recorded for each text. Income distribution means 15 refers to the record of the text database and sums up the advertisement income in the target period.

Income distribution means 15 distributes (at step S604) the advertising income in the target period to the operator, the original text publisher, and the translator. The distribution ratio between the original text publisher and the translator is predetermined. Income distribution means 15 performs a process of paying the distributed advertisement income to the original text publisher and the translator.

### 2-5. User Profile Display

A reward amount for the translator is accumulated each time a uploaded translation is adopted, and each time advertisement income from the published translated text is distributed. The compensation amount is integrated for each language. The integrated value of the reward amount is recorded in the user database as profile information of each translator. Profile output means 163 transmits the profile information of the translator in response to a request from the original text publisher terminal 3-1. The original text publisher can confirm the profile of the translator at the original text publisher terminal 3-1.

The profile of the translator is referred to, for example, when the original text publisher approves the translated text. If the original text publisher is unable to evaluate the translated text, such as in a case that the original text publisher is not familiar with the translation target language, the original text publisher refers to the translator's profile.

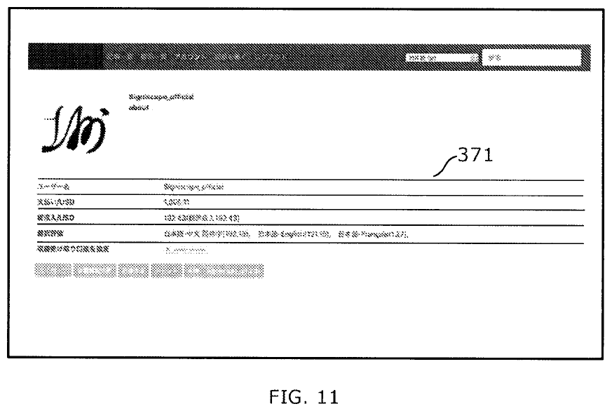

FIG. 11 shows an example of the translator profile view screen. The profile view screen includes profile field 371. Profile field 371 is a UI object for displaying a user's profile, e.g., username, total income amount, and language-specific evaluations. The total income amount is the sum of the income from the translation compensation and the income from advertisement, but each income may be individually displayed. As the evaluation for each language, an integrated value of the reward amount already obtained by the translator is used. Alternatively, as the evaluation, an average value of the evaluation from the original text publisher or the general user for the uploaded translated text may be used.

In the example shown in FIG. 11, the translator has a history of translation from Japanese to Chinese, from Japanese to English, and from Japanese to French, and each evaluation is displayed. In a case that the evaluation by the original text publisher is used as the evaluation of the translator, the evaluation by the original text publisher is input from the original text publisher terminal 3-1 when the translated text adopted by the original text publisher is approved at step S513 in the sequence shown in FIG. 5. In addition, a function of evaluating the translated text by the general user when the general user views at step S532 the general user terminal 3-m in the sequence of FIG. 5, may be added.

### 3. Modification

The present invention is not limited to the above described embodiments, and various modifications can be applied to the embodiment. Examples of these variations are described below. Some of the items described below may be combined with other item(s).

### 3-1. Generation of a Translation Request

In the above described embodiment, the request generation means 14 generates the translation request in response to reception of the original text. However, the event that triggers generation of the translation request is not limited to that when the original text is provided from client terminal 3. For example, an example is envisaged in which a text translated into the second language is approved in a state in which a translation request from the first language to the second language and a translation request from the first language to the third language are generated in response to provision of the original text. At this time, the request generation means 14 may generate a translation request from the second language to the third language, when the translated text in the second language has been approved (or the translated text in the second language has been published). For example, an example is envisaged in which the original text is written in Japanese, and English and French are designated as the translation target language. In this example, it is assumed that a text translated into English is uploaded by a particular translator, and the translated text is approved by the original text publisher.

When approval receiving means 113 receives approval of the text translated into English, request generating means 14 generates a translation request from English to French relative to the original text. As compensation for the translation, a compensation for the translation from Japanese (that is, the first language) to French (that is, the third language) is applied. At this point, a request for translation from Japanese to French and a request for translation from English to French coexist. A greater variety of source languages will increase the number of potential translators. This will increase the likelihood of obtaining high quality translated texts at a lower cost.

A case is envisaged in which a translation request from the first language to the third language and a translation request from the second language to the third language coexist. At this time, there is a possibility that an unapproved translated text from the first language to the third language and an unapproved translated text from the second language to the third language may coexist. Original text publishers must select a translated text for approval. Approval of the translated text is performed via the text list screen as shown in FIG. 9. In the text list screen, an unapproved translated text from the first language to the third language and an unapproved translated text from the second language to the third language are displayed, and at this time, in each translated text, a correspondence relationship with the translation source language can be visually expressed. For example, an unapproved translated text from a first language to a third language is displayed in a single-level indented state under the original text, and an unapproved translated text from a second language to a third language is displayed in a second-level indented state under a translated text in a second language (one-level indented from the original text). By this display, the original text publisher can visually perceive and understand with ease a relationship between the translation source language and the translation target language.

In addition, when the translated text from the second language to the third language is finally approved, income distributing means 15 may distribute the advertising income corresponding to the page view of the translated text of the third language to the third person of the original text publisher, the second language translator, and the third language translator.

### 3-2. Output of the Translation Request

A method for outputting, by request list output means 162, the list of translation requests is not limited to the example described in the embodiment. In the embodiment, an example is described in which server 1 outputs a list of translation requests in response to access from the translator, but server 1 may push the list of translation requests to one or more translators. In addition, in the embodiment, information described as being transmitted from server 1 in response to an access from a push notification may be distributed from server 1 to the user.

### 3-3. Designation of Translator

In receiving the translation request, text receiving means 111 may receive the designation of the translator. In this case, for example, the posting screen (shown in FIG. 6) of the text includes the designation field of the translator. Text receiving means 111 receives the designation of the translator via the designation field. In another example, the profile view screen of the translator (shown in FIG. 11) includes a designation field of the original text and a button for the translation request. Text receiving means 111 receives a translation request (including designation of the original text) via the designation field and the button.

### 3-4. Displaying Translated Texts

The method of displaying the list of unapproved translated texts is not limited to that shown in FIG. 9. When displaying a list of translated texts in a language for an original text, the translated texts are arranged in an order according to predetermined criteria. As predetermined criteria, for example, a time at which a translated text is uploaded or an evaluation of a translator is used. Further, FIG. 9 shows an example in which the original text, the unapproved translated text, and the approved translated text are displayed on the same screen, but the original text and the translated text may be displayed on separate screens. Additionally or alternatively, the unauthorized translated text and the approved translated text may be displayed on separate screens.

### 3-5. Timing of Publication of Translated Texts

In the above described embodiment, an example in which a translated text is published in response to completion of provision of the compensation to the translator is described, but a timing at which the translated text is published is not limited thereto. Text publishing means 13 may publish the translated text without waiting for completion of the provision process of the compensation after receiving approval of the translated text to be adopted by the original text publisher.

### 3-6. Information Contained in the List of Texts

In the above described embodiment, the list of translation requests (shown in FIG. 7) describes the content of the request for translation for each original text, but the information may include information indicating a number of translated texts that have already been uploaded for each translation target language. For example, a case is envisaged in which a translation request for English and French is active for a particular original text, if the translator designates English as the translation target language, the list of translation requests generated by request list output means 162 includes information indicating how many translated texts in English have already been uploaded for the original text (these are not approved). This information enables the translator to understand how many competitors exist.

### 3-7. Determination of Share

The distribution ratio of the advertisement income between the original text publisher and the translator is not limited to that shown in the embodiment. Income distribution means 15 may determine, for example, a distribution rate of the advertisement income of the translated text in the second language based on a page view of the original text and a page view of the text translated into the second language. Specifically, in a case that the page view of the text translated into the second language is significantly greater than the page view of the original text, income distribution means 15 sets a relatively higher distribution rate for the translator of the second language. When determining whether there are significantly more page views, for example, at least one of a population of the language, a page view of other texts belonging to a same genre, and a page view of other texts in the language is considered. As an example, if the original text in Japanese is 10,000 page views per month, and the translated text in French is 100,000 page views per month, it is concluded that there are relatively many page views of translated texts in French, even when taking into account the Japanese language population (about 120 million people) and the French language population (about 300 million people). In such a case, the distribution ratio of translators should be increased above a usual ratio because it may be concluded that in addition to a high content worth of the original text, translation skills and recognition of translators in the French language sphere are influencing factors in readership. Similarly, income distribution means 15 may determine a distribution rate of the advertisement income of the text translated into the third language based on the page view of the text translated into the second language and the page view of the article translated into the third language.

### 3-8. Ranking of Translators

Information processing system S may provide a ranking of a translator. A ranking of a translator is generated based on evaluation (e.g., an integrated value of an obtained reward amount). The page for displaying the ranking of the translator may be accessible to anyone or may be published only to users who satisfy certain conditions (e.g., users subscribing to a paid plan). The original text publisher can refer to the ranking of the translator and designate the translator to make a translation request.

### 3-9. Object of Translation

The content to be translated is not limited to a character string (i.e., text). The original text publisher may publish an image of the original text (or a part of the original text). In this case, the original text publisher requests translation of the character string included in the image. The image posted as text, may include material of a comic, a restaurant menu, or a poster. When publishing the image, the original text publisher designates a target region for translation. Alternatively, the target area may be automatically designated using an AI technology or the like. The area to be translated is, for example, a balloon in a comic. The translator translates the character string included in the target area into a designated language.

### 3-10. Preventing Fraud

In information processing system S, there is a possibility that the fraud may be carried out, as follows. For example, an original text publisher who is reluctant to pay compensation may create another user account (referred to as user X). In response to a translation request for the original text, a legitimate user (referred to as user Y) posts a translation of the text. The original text publisher views the translated text uploaded by the user Y and copies the translated text and posts the translated text as user X. The original text publisher approves the translated text of user X. In this way, the original text publisher can obtain the translated text without substantially paying compensation.

From a viewpoint of preventing such fraud, server 1 calculates a degree of coincidence between a translated text uploaded later in time and a translated text uploaded within a time earlier than that of the translated text. If a degree of coincidence between the newly uploaded translated text and the previously uploaded translated text exceeds a threshold value (for example, 90%), server 1 determines that the new translated text is a text suspected of being fraudulent. Server 1 may, for example, restrict a text suspected of being fraudulent.

### 3-11. Other Embodiments

The hardware configurations of server 1 and client terminal 3 are not limited to those shown in the embodiments. As long as the required functions can be implemented, server 1 and client terminals 3 may each have any hardware configuration. For example, a group of two or more computer devices may function as server 1. Further, allocation of functions between server 1 and client terminal 3 is not limited to those described in the embodiment. In the embodiment, a part of the functions described as those of server 1 may be implemented in client terminal 3.

The program executed by processor 101 or the like may be downloaded to a computer device via a communication network such as the Internet or may be distributed with a non-transitory computer-readable recording medium such as a CD-ROM.

1. An information processing device comprising:
a first receiving means for receiving, from a first user, an original text in a first language, a request for translation of the original text, a designation of a second language for the translation, and a designation of a compensation for the translation;
a second receiving means for receiving, from one or more second users, without prior agreement with the first user, a translation of the original text into the designated second language;
a first output means for outputting to the first user a list of received translated texts;
a third receiving means for receiving approval of a translated text to be adopted from the list output by the first output means;
a providing means for providing the compensation to a second user, from among the one or more second users, who uploaded the approved translated text; and
a publishing means for publishing the original text and the approved translated text.

2. The information processing device according to claim 1, further comprising:
a generating means for generating a request for translation of the original text into the designated second language upon receipt by the first receiving means of the request for translation of the original text; and
a second output means for outputting to the one or more users of the designated second language a list including the generated request.

3. The information processing device according to claim 2, wherein
the first receiving means receives, in addition to the designated second language, a designated third language,
the generating means generates a request for translating the original text into the designated third language from the approved second language translation, in response to approval for the second language translation is received by the third receiving means.

4. The information processing device according to claim 1, wherein
the second output means outputs a list of texts for which translation into the designated second language is requested, in response to access from the one or more users of the designated second language.

5. The information processing device according to claim 1, wherein
the publishing means publishes the translated text upon receipt of approval by the third receiving means.

6. The information processing device according to claim 1, further comprising
distribution means for distributing an advertisement income to the first user and the second user according to an index of advertisement income for the translated text.

7. The information processing device according to claim 6, further comprising
a third output means for outputting information that shows an amount of the compensation and the distributed advertisement income as a profile of the second user.

8. The information processing device according to claim 7, wherein
the list of texts for which translation into the designated second language is requested includes information indicating a number of translated texts already uploaded responsive to the request.

9. An information processing method comprising:
receiving, by a computer system, from a first user, an original text in a first language, a request for translation of the original text, a designation of a second language for the translation, and a designation of a compensation for the translation;
receiving, by the computer system, from one or more second users, without prior agreement with the first user, translation of the original text into the designated second language;
outputting, by the computer system, to the first user, a list of received translated texts;
receiving, by the computer system, approval of the translated text to be adopted from the list output by the first output means;
providing, by the computer system, the compensation to a second user from among the one or more second users, who uploaded the approved translated text; and publishing, by the computer system, the original text and the approved translated text.
